(19) United States
(12) Patent Application Publication
(10) Pub. No.: US 2018/0181975 A1
(43) Pub. Date: Jun. 28, 2018

(54) SYSTEM AND PROCESS FOR DELIVERING ADVERTISING

(71) Applicants: GINA SILVERMAN-SMITH, (US); TODD SILVERMAN, (US)

(72) Inventor: JOHN SILVERMAN, El Paso, TX (US)

(73) Assignees: GINA SILVERMAN-SMITH, El Paso, TX (US); TODD SILVERMAN, El Paso, TX (US)

(21) Appl. No.: 15/392,417

(22) Filed: Dec. 28, 2016

(51) Int. Cl. G06Q 30/02

(52) U.S. Cl. CPC G06Q 30/0209; G06Q 30/0269; G06Q 30/0277; G06Q 30/0267

(57) ABSTRACT

Described is a system and process for delivering advertising wherein advertisers can ensure advertising material is considered only by interested consumers, without inefficient generation of large amounts of advertising material for presentation to disinterested consumers. The system includes a game server, a coupon server, and a payment server. The process involves a “game” wherein the user may “win” a chance to share in a prize, such as a cash prize. The system presents the user with a series of coupon offers submitted by advertisers, wherein the system requires the user to view and evaluate each coupon offer and to decide whether to retain the coupon prior to receiving each of a plurality of game plays. Advertisers pay to populate the system with ads, creating a payment pool from which user payments and a system profit are funded.

### BACKGROUND OF THE INVENTION

### Technical Field

This invention relates to advertising; and, specifically, to a system and process for creating advertising material which must be considered by a consumer.

### State of the Art

To be effective, advertising of goods and services for purchase requires a potential customer to whom an advertisement is directed 1) receive the ad; 2) consider the ad; and 3) is caused by the ad to make a favorable decision regarding the advertised product. Ads may be delivered to the consuming public in a multitude of creative yet familiar ways. Customer receipt of ads, therefore, presents no unusual or unique technical challenges.

Consideration of the ad by a potential customer, however, is not so straightforward. Billboards, magazine and newspaper ads, television commercials, online “pop-up” ads, and the like expose virtually all members of society to a constant, daily barrage of advertising material. Predictably, therefore, most consumers become desensitized to such advertising. Because so many ads are seen or heard during daily life, consumers often fail to consider using, or even become aware of the advertised product. Furthermore, although efforts by advertisers to target specific consumers have become considerably more sophisticated, widespread use of digital video recorders, Internet streaming, and online/paper media content subscription services may or may not successfully deliver ads to customers truly interested in a specific product. Consequently, only a tiny fraction of consumers ever actually consider the ad, much less make a decision favorable to the advertiser to purchase the product.

This massive dilution of the target consumer audience results in advertising which is less effective and more costly for the advertiser. If the vast majority of money spent on advertising results in ads delivered to consumers who will never make a decision about whether to purchase or try-out the advertised product, then a substantial amount of advertising dollars are wasted.

Accordingly, what is needed is a process, including a system, apparatus, and methods of implementation, for engaging a consumer and causing the consumer to consciously consider an ad, wherein the consumer makes an immediate decision regarding the advertised product.

### BRIEF DESCRIPTION OF THE DRAWINGS

FIG. 1 is a simplified diagram representing a system for delivering advertising;

FIG. 2 is a schematic diagram of a system for delivering advertising;

FIG. 3 is an additional schematic diagram of a system for delivering advertising;

FIG. 4 is an additional schematic diagram of a system for delivering advertising;

FIG. 5 is a diagram of a play group;

FIG. 6 is a schematic diagram of an array of play symbols;

FIG. 7 shows a schematic diagram of a game play;

FIG. 8 is schematic diagram of a game turn;

FIG. 9 shows a block diagram of a method of providing an advertisement to a consumer;

FIG. 10 shows a block diagram of a method of compelling a consumer to interact with an advertisement; and

FIG. 11 shows a block diagram for collecting advertiser revenue.

### DETAILED DESCRIPTION OF EMBODIMENTS OF THE INVENTION

Unwanted advertising, such as Internet pop-up ads, create an annoyance for persons using the Internet. The user must either tune-out the commercial, wait for the commercial to end, or perform an action to skip the commercial. Moreover, Internet advertising positioned between paragraphs or in the midst of a streaming broadcast are often skipped-over by the user. In fact, users of the Internet sometimes incur expense to block this unwanted advertising. For example, many of today's Internet users have installed ad blocking software on their computing devices. As a result, in 2014, content providers lost an estimated $5 billion in ad revenue due to ad blockers.

Coupons offered by advertisers provide motivation for potential consumers to view advertising of interest to the consumer. Internet-based coupons are gaining popularity across multiple consumer demographics. It is estimated that 80% of all consumers use coupons, at least episodically. At least 25 million American consumers use mobile computing device, such as smartphone-based, coupons each month. For example, in 2014, it is estimated that 47 million Americans used a smartphone to redeem a mobile coupon. Half of these redeemed coupons originated from advertising coupled to social media websites and platforms. Business websites received a total of 48 million visitors each month in 2014. Mobile coupons are at least 10 times more likely to be redeemed than traditional coupons. Mobile coupon redemption through tablets and smartphones is predicted to surpass $10 billion.

The disclosed invention creates an alternative to advertisers seeking to efficiently use their advertising resources by reaching only potential consumers who are actually interested in the advertised product. The invention creates a guarantee that advertising submitted by the advertiser is not only viewed in its entirety, but that the potential consumer cognitively interacts with the advertising material by making and logging a decision whether to accept or reject a coupon offer from the advertiser. The potential consumer using the system discloses is “playing” a “game,” wherein the advertising material is only presented to consumers who request to receive a coupon offer. Potential consumers are motivated to play the game, in some embodiments, by the chance to win a share of a prize, such as a cash prize, received upon completing the game by submitting a winning play.

As discussed above, embodiments of the disclosed invention relate to advertising; and, specifically, to a process and apparatus for creating advertising material guaranteed to be viewed by a consumer. Disclosed is a system engaging a consumer to view advertisements in exchange for receiving discount coupons and a chance to share in a lottery-type cash prize. The system and process for delivering advertising comprises a group of servers wherein data sets, including rules of play and current players of a game, electronic advertisements and advertiser coupons, and payments to users and advertisers are stored and delivered to players of the game, representing potential consumers of the advertised products. Consumer users are motivated to “play” the game—wherein they are required to view and make a decision on an advertised product—by a chance to win a portion of the cash lottery. Advertisers populate the system with promotional material, comprising electronic ads and coupons for their products, in exchange for tendering payments into the system which, in part, fund the lottery. Consumer users of the system are compelled to sequentially view multiple electronic ads, wherein the user 1) must read and consider the ad; in order to 2) make a decision whether to retain a particular coupon coupled to each ad viewed. Only after the user transmits the decision to the system is the user presented with a game play. Successful completion of a “turn” comprising a series of game plays allows a the user to submit a “winning play,” wherein the user will receive a portion of the prize “jackpot.”

Participating advertisers fund a lottery-type payment into the system each time a coupon provided by the advertiser is both viewed and either selected or declined by a user. The advertiser payments are pooled and a portion of this payment pool is offered as a daily jackpot, wherein the jackpot is distributed each day to consumer users of the system who have submitted winning plays. A portion of the payment pool may additionally be distributed as profit to the administrator of the system.

The system may be accessed by a user through a remote computing device, such as a desktop computer or a smartphone. The user may play one game or multiple games, according to the user's available time and preferences. Some users will utilize the system to accumulate coupons for discounts on goods and services they desire, because each viewed ad is coupled to a coupon. The user has a choice regarding the coupon and may elect to either download for redemption, or return the coupon to a community coupon bank, from where the system makes the coupon available to pair with an ad and offer to a different user coupled to a game play. Selected coupons may be downloaded for printing or stored electronically on the user's computing device.

It is desirable for an advertiser to optimize its advertising efficiency by reaching only specific consumers who are interested in purchasing an advertised product while not subjecting disinterested persons to undesired advertising. It is also desirable for consumers who are interested in certain goods and services to initiate reception of advertisements in exchange for discount coupons and a chance to receive a cash payment from pooled payments in a bank funded by advertisers. It is additionally desirable to compel a consumer to view and cognitively interact with a series of advertisements by entertaining the consumer with an interactive lottery-type game.

A ‘utility’ as used herein refers to any device or software that creates an output, performs a task on an input, or performs a computation, in response to receiving an input. A utility can be software code, an electronic circuit, a combination of hardware and software, a programmable device, application specific hardware, or any other implementation of hardware circuits or software that accomplishes a task or computation.

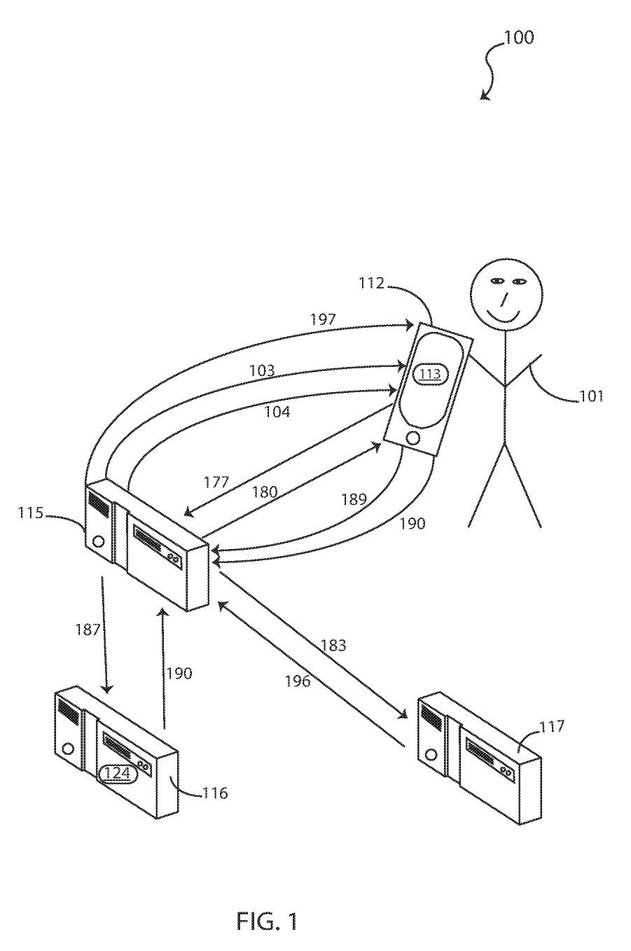

FIG. 1 shows a simplified diagram representing a system 100 for delivering advertising. System 100 comprises, in part, three servers: a game server 115; a coupon server 116, and a payment server 117. Game server 115, coupon server 116, and payment server 117 each represent a computing device comprising at least a microprocessor and a memory. Any computing device that can store and/or process data and can be communicatively coupled to one or more additional computing devices may comprise game server 115.

In the embodiment of system 100 shown in FIG. 1, game server 115 is communicatively coupled to each of coupon server 116 and payment server 117. In some embodiments, game server 115, coupon server 116, and payment server 117 are all physically located proximate to one another, such as in the same room or building, or even in the same computing device. Game server 115, coupon server 116, and payment server 117 are shown in FIG. 1 as physically separate devices, however, for the primary purpose of describing system 100 with clarity. In some embodiments, game server 115 and/or coupon server 116, and/or payment server 117 are placed in physically separate locations, without limitation. For example, in some embodiments of system 100, game server 115 and coupon server 116 are positioned in a physical location controlled by an owner/administrator of system and 100 and payment server 117 is positioned in a physical location controlled by a banking institution, an accounting company, an advertising agency. Game server 115, coupon server 116, and payment server 117 may be physically located together or apart in any combination of one, two, or three separate physical locations without limitation. The only location requirement is that a means for communicatively coupling game server 115 to coupon server 116, payment server 117, and a remote computing device 112 be available at the location. Such coupling means include, but are not limited to, a direct physical-wired electrical coupling between servers; coupling through a wired network, such as with an Ethernet cable connection; and coupling through a wireless network connection, such as a WiFi radio network connection.

Game server 115 is additionally communicatively coupled to a remote computing device 112. Remote computing device 112 is represented in FIG. 1 by a mobile computing device; i.e., a cellular telephone or a smartwatch. Remote computing device 112 comprises the means wherein a user 101 interacts with system 100 through game server 115. In some embodiments, remote computing device 112 is a desktop computer. These examples are meant to be limiting regarding the form of remote computing device 112.

In some embodiments wherein remote computing device 112 is a smartphone or a smartwatch, a game app 113 is resident on remote computing device 112. Game app 113 comprises a utility which generates a graphical user interface onto a display of remote computing device 112 wherein information received from game server 115 is displayed to user 101 and wherein user 101 provides a response to the displayed information causing remote computing device 112 to send one or more various signals to game server 115, as discussed in detail herein below.

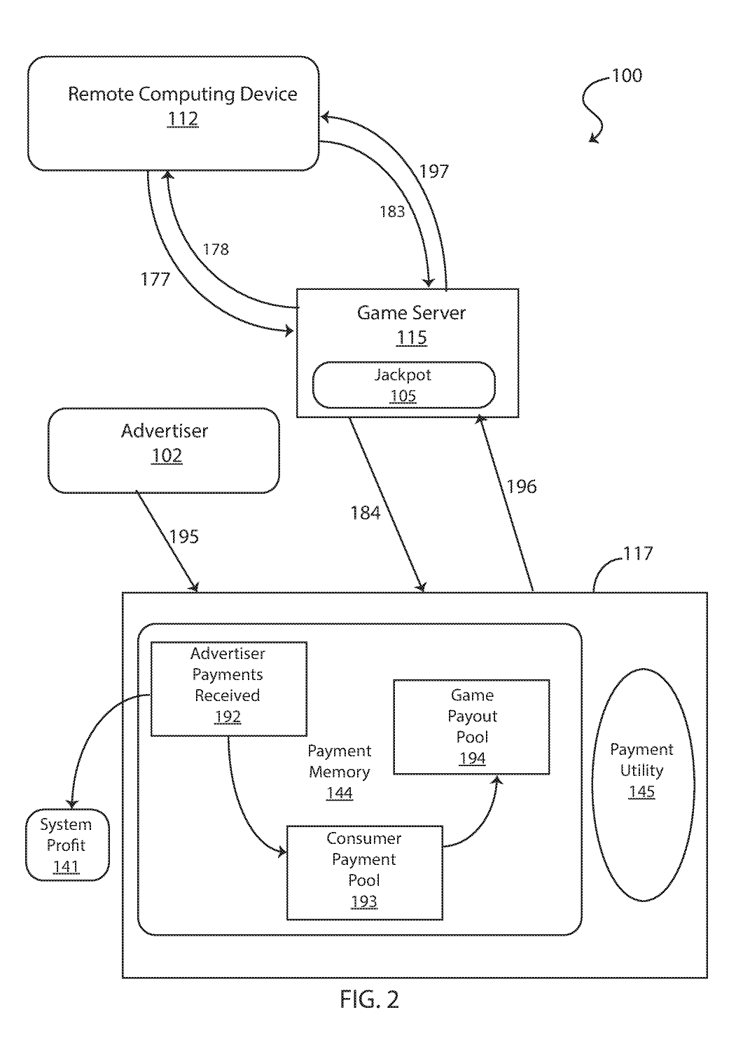

FIG. 1 further shows signals sent between game server 115 and each of remote computing device 112, coupon server 116 and payment server 117. Examples of signal exchanges comprising system and process 100 are listed herein. Game server 115 receives a total payment 196 from payment server 117 in response to sending a winning play signal 183 to payment server 117. Game server 115 receives an accept coupon signal 190 from coupon server 116 in response to sending a coupon request signal 187 to coupon server 116. Additionally, game server 115 may send an advertisement 103, a coupon 104, and a play symbol 180 to remote computing device 112 in response to receipt of a game turn request 177 from remote computing device 112. Remote computing device 112 sends a reject coupon signal or an accept coupon signal 190 to game server 112 in response to a decision input from user 101 whether to reject or accept coupon 104. The foregoing and other signals exchanged between game server 115 and other computing devices comprising system 100 are discussed in greater detail herein, with reference to FIGS. 2-5.

FIG. 2 shows a schematic diagram of a system for delivering advertising. FIG. 2 illustrates how system 100 collects, records, calculates, and distributes payments. Payment server 117 comprises a payment memory 144 and a payment utility 145. In some embodiments, including the example embodiment shown in FIG. 2, elements resident in payment memory 144 include an advertiser payments received 192, a consumer payment pool 193, and a game payout pool 194. Payments from participating advertisers are received by payment server 117 in exchange for distribution of the advertisers' product ads to potential consumers by system 100. Payment server 117 may store an advertiser's financial account information, receive electronic transfer of payments from advertisers, record and store payments, and calculate and distribute payments to consumers and a system administrator.

For example, in some embodiments, an advertiser 102 transmits an advertiser payment 195 to payment server 117, wherein the payment is received by advertiser payments received 192. Advertiser 102 may initiate advertiser payment 195 from an account at a separate bank or financial institution through any established available means of payment transfer, electronic or otherwise. In some embodiments, payment utility 145 calculates an amount to remove from advertiser payments received 192 as a system profit 141. Wherein system 100 generates revenue, system profit 141 goes to the owner, administrator, or the like. System profit 141 may be determined by any algorithm, formula, method, etc. based upon advertiser payments received 192 calculated by payment utility 145. Following removal of system profit 141 from advertiser payments received 191, payment utility 145 allocates funds from advertiser payments received 191 to a consumer payment pool 193. Consumer payment pool 193 is the total amount funded for eventual payment to users of system 100, in the form of a prize, such as a cash prize, for playing a game linked to receipt of advertising. At intervals, such as once each day, for example, payment utility 145 calculates a game payout pool 194 based upon an algorithm provided the administrator of system 100 for distribution to a plurality of consumer-user 101 “winners” who have accessed system 100 and submitted winning game plays on that day. Payment utility 145 causes payment server 117 to send a total payment 196 to game server 115 in response to receipt of one or a plurality of a total winning play signal(s) 184 from game server 115.

As further shown by FIG. 2, game server 115 receives a total payment 197 comprising game payout pool 194 from payment server 117 as a jackpot 105, wherein game server 115 calculates a distribution of jackpot 105 to one or a plurality of users 101 of remote computing device(s) 112 utilizing system 100 to view advertising in exchange for playing a game with a cash prize, such as a lottery game, for example. A user of remote computing device 112 initiates receipt of advertising from game server 115 by causing remote computing device 112 to send a game turn request 177 to game server 115. Initiation of receipt of advertising, in some embodiments, is caused by user 101 interacting with game app 113 resident on remote computing device 112. Game server 115 sends a game turn 178 to remote computing device 112 in response to receipt of game turn request 177 from remote computing device 112. Depending upon the characteristics and rules of the game utilized by system 100 to compel consumers to view and interact with advertising, receipt of one or a plurality of winning play signals 183 from remote computing device 112 causes game server 115 to calculate a user payment amount and subsequently send a user payment 197 to remote computing device 112. User 101 may redeem user payment 197 through a standard means available in commerce via game app 113, or via other software means resident on remote computing device 112.

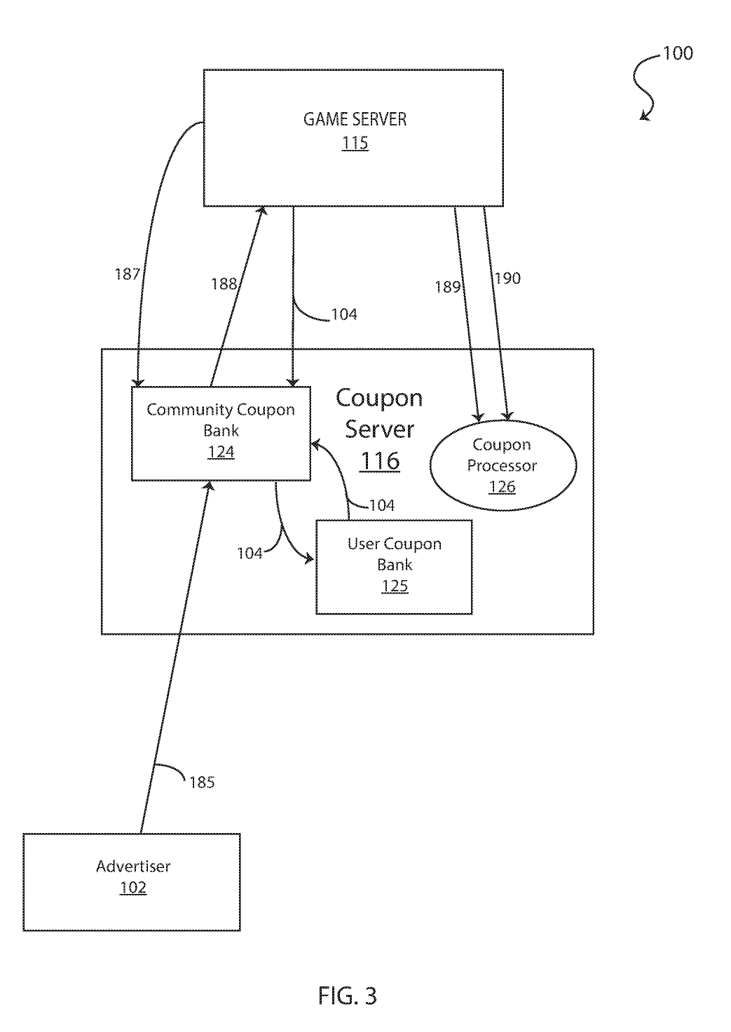

FIG. 3 shows an additional schematic diagram of a system for delivering advertising. A central element of system 100 is the requirement for a consumer, such as user 101, to 1) view an advertisement; and 2) interact with the advertisement in a conscious manner requiring the consumer to make a decision about the advertisement. The conscious interaction occurs wherein user 101 must decide whether to keep or return a coupon. In some embodiments, system 100 provides confirmation of this interaction to advertiser 102.

As shown in FIG. 3, coupon server 116 comprises a community coupon bank 124, a user coupon bank 125, and a coupon processor 126, in some embodiments. Community coupon bank 124 and user coupon bank 125 are any hardware and software means for storage of data on a server or related computing device comprising a memory. In some embodiments, community coupon bank 124 and user coupon bank 125 are parts of a single larger data storage means, such as partitions on a single hard drive. Coupon processor 126 may be a microprocessor communicatively coupled to community coupon bank 124, user coupon bank 125, and game server 115.

In a specific example embodiment of system 100, such as that embodiment shown in FIG. 3, advertiser 102 sends a provide coupon signal 185 to coupon server 116. Coupon signal 185 may comprise a data signal with information about an advertised product, a discounted price for the product, store location or other information wherein a recipient of the coupon presented by coupon data signal 185 may redeem the coupon, and additional information related to the coupon provided by advertiser 102. Coupon processor 126 interprets provide coupon signal 185 by identifying the advertiser and the details of the coupon discount/offer, and stores this information in community coupon bank 124 for later retrieval by system 100. Coupon processor 126 repeats this for a plurality of advertisers, wherein community coupon bank 124 becomes populated with data comprising relevant information on a plurality of advertiser coupons. A coupon discount/offer may later be selected from community coupon bank 124 by system 100 for offer to user 101. The details addressing how system 100 performs this selection are discussed herein below.

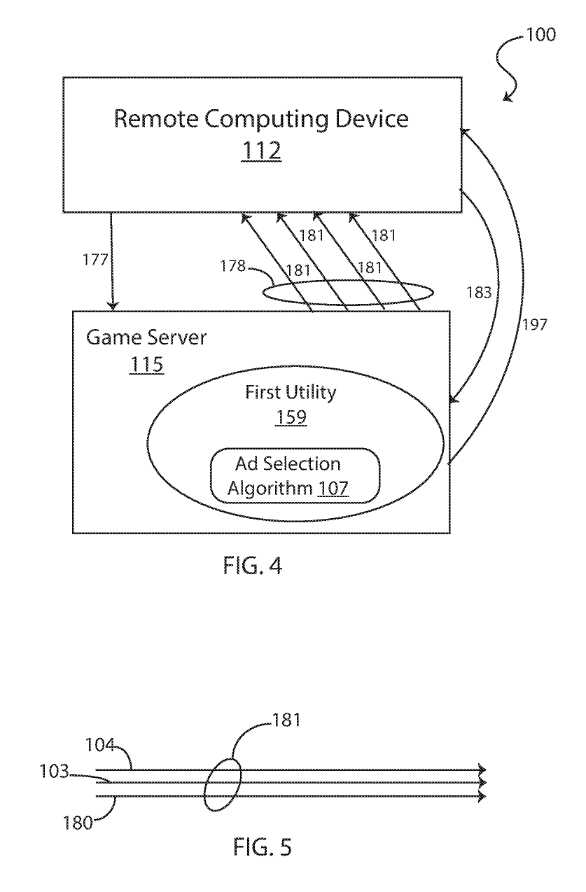

Community coupon bank 124 sends a coupon delivery signal 188 to game server 115, in response to receiving a coupon request signal 187 from game server 115. Game server 115 generates coupon request signal 187 following an interaction of user 101 with remote computing device 112 to initiate a game “turn,” also discussed further herein below (See FIG. 4). Coupon delivery signal 188 comprises a coupon 104 which game server 115 transfers to remote computing device 112 (not shown in FIG. 3). User 101 interaction with remote computing device 112 causes game server 115 to send one of either a reject coupon signal 189 or an accept coupon signal 190 to coupon processor 126. Coupon processor 126 responds to a reject coupon signal 189 by re-saving coupon 104 returned from game server 115 to community coupon bank 124. Conversely, receipt of accept coupon signal 190 from game server 115 causes coupon processor 126 to delete data relevant to coupon 104 from community coupon bank 124.

In some embodiments, user coupon bank 125 is communicatively coupled to community coupon bank 124, wherein coupon 104 may be exchanged between bank 124 and bank 125. This subdivision of coupon banks is advantageous, because in some embodiments, advertiser 102, for example, may deactivate coupon 104 or designate a date, a plurality of dates, or a date range wherein coupon 104 is available for display to a user on game server 115 and other dates wherein coupon 104 is not available for distribution. In may be desirable, therefore, to temporarily remove and store certain coupons 104 separate from community coupon bank 124, wherein coupons 104 stored in user coupon bank 125 are not available for coupon server to send to game server 115. There may be additional examples wherein it is desirable to separate coupon data between community coupon bank 124 and user coupon bank 125, adding versatility to system 100. In some embodiments, coupon server 116 only comprises community coupon bank 124 and does not comprise user coupon bank 125. In some embodiments, coupon processor 126 pairs a specific coupon 104 to a specific user 101 based upon user demographic data (not shown; discussed further herein below) compiled by and received from game server 115.

FIG. 4 shows an additional schematic diagram of a system for delivering advertising. As shown in FIG. 4, remote computing device 112 is communicatively coupled to game server 115, wherein remote computing device 112 and game server 112 exchange certain signals comprising system and process 100. (See also FIG. 1.) These signals include signals for executing game play, signals for exchanging coupons, and signals for providing payment. It is understood that remote computing device 112 is physically “remote” from game server 115, wherein the communicative coupling of remote computing device 112 to the remainder of system 100 through game server 115 is required to maximize the number of users 101 of system 100. The plurality of users 101 may be located in a specific region wherein advertiser 102 markets its goods and services, such as a city, a state, or a country. Depending upon the product(s) advertised and a specific advertiser 102, system 100 may operate throughout a global region, such as North America, Europe, Asia, or globally. Communicative coupling between remote computing device 112 and game server 115 is accomplished, therefore, by standard means, such as by a wired Ethernet connection, cellular or other wireless connection, and the like.

Upon completion of game turn 178 by user 101, in some embodiments, remote computing device 112 generates a winning play signal 183, wherein game server 115 responds to receipt of winning play signal 183 from remote computing device 112 by sending user payment 197 to remote computing device 112. Winning play signal 183 is only generated upon user 101 “winning the game.” The requirements necessary to “win the game” vary among different embodiments of system 100, such that an owner/operator of system 100 may design any of an unlimited number of “games,” each with unique rules, restrictions, odds of winning, etc., without limitation. This versatility built into system 100 creates applicability for many advertisers offering different products in different markets to consumers with any number of ages, socioeconomic and cultural backgrounds, experiences, and other demographic differences. The common feature, however, remains that system 100 compels a targeted group of consumers to view and cognitively interact with advertising in order to “play” a game for a chance to win cash or a similar prize of value.

In some embodiments, game server 115 comprises a first utility 159. First utility 159 comprises software resident on game server 115 which performs functions related to conducting the “game,” wherein to “play” the game, user 101 must view advertisements and makes a decisions on whether to accept each of a plurality of presented offers for coupon 104. In some embodiments, each coupon offer is presented to user 101 separately, wherein user 101 must interact with the coupon offer in order to receive a play group 181. In the example embodiment shown in FIG. 4, game server 115 sends a game turn 178 comprising a plurality of play groups 181 to remote computing device 112 in response to receipt of a game turn request 177 from remote computing device 112. Game turn request 177 follows an interaction by user 101 with its remote computing device 112. Such an interaction may occur through prompts displayed by game app 113 onto a graphical user interface of remote computing device 112, for example. Game server 115 responds to receipt of game turn request 177 by sending a game turn 178 to remote computing device 112.

FIG. 5 shows a diagram of a single play group 181. Play group 181 is a signal group compiled by first utility 159 of game server 115 to provide remote computing device 112 with information related to viewing of and interaction with advertising by user 101, coupled to information for game play, such as a play symbol 180, to remote computing device 112. Play group 181 is a signal group comprising an advertisement 103, coupon 104, and play symbol 180, in some embodiments. For each play group, user 101 must respond to offer of a single coupon 104 by viewing advertisement 103 and deciding whether to accept or reject coupon 104.

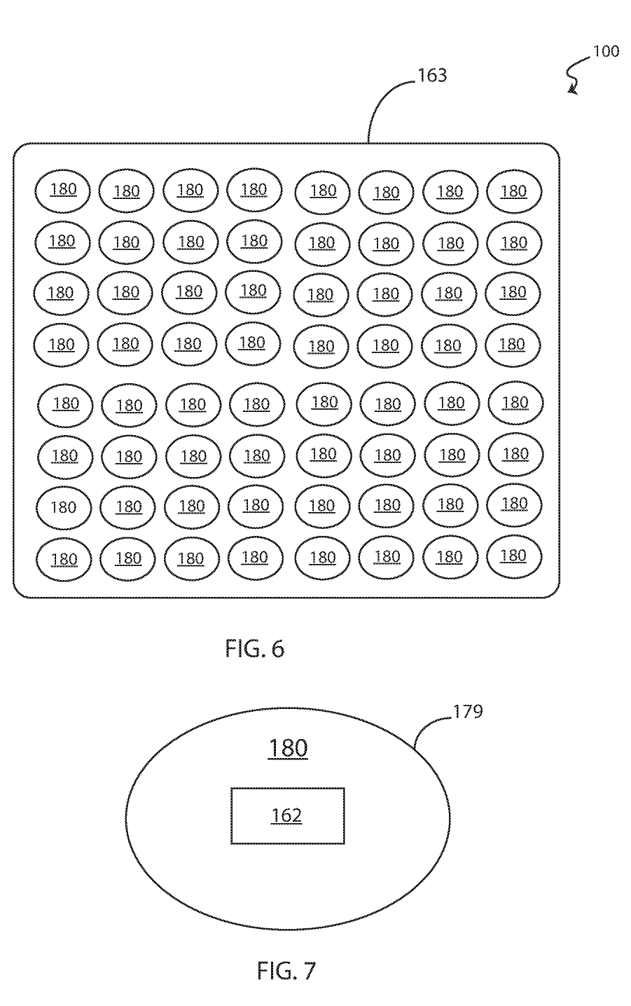

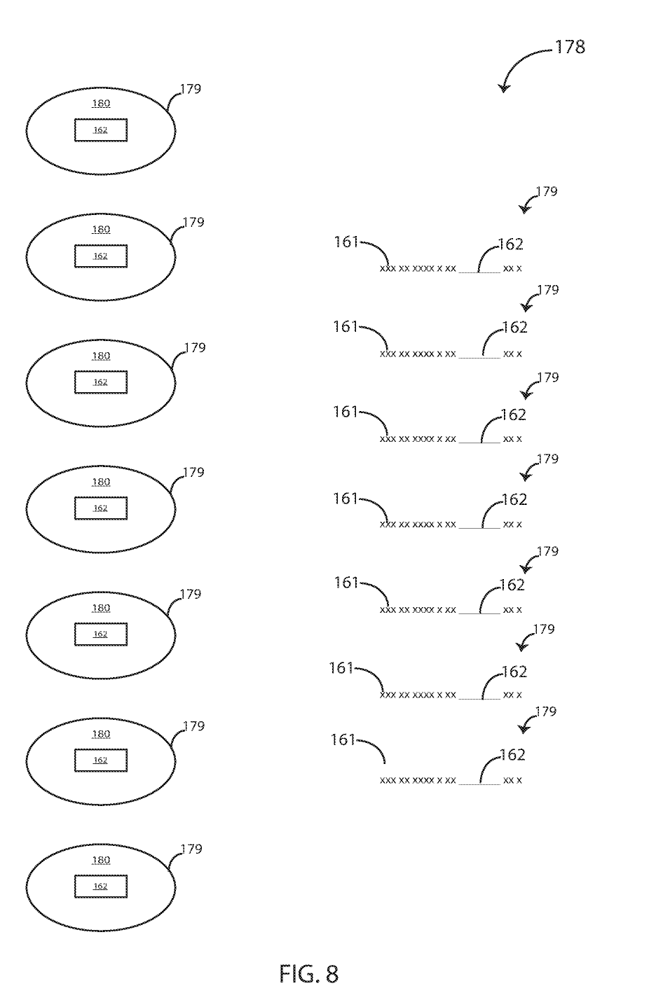

FIG. 6 is a diagram of an array 163. FIG. 7 is a diagram of a play 179. FIG. 8 is a diagram of game turn 178. To illustrate conduct of an example game turn 178, FIGS. 6-8 are presented and discussed together.

Turning first to FIG. 6, array 163 is a plurality of play symbols 180 presented in a group to user 101 on the display of remote computing device 112. Each play symbol 180 masks a single answer 162, as shown in FIG. 7. Answer 162 is a response, which may be correct or incorrect, to a question 161, as shown in FIG. 8. In order to remove play symbol 180 and unmask underlying answer 162, user 101 must complete an interaction with advertiser 102's offer of coupon 104. For each play group 181 comprising game turn 178, therefore, user 101 chooses a specific play symbol 180 and completes play 179 by viewing advertisement 103 and making a decision regarding coupon 104. FIG. 6 shows an 8×8 array 163 comprising 64 play symbols 180, however this is by way of example only and not meant to be limiting. Array 163 may form any shape and comprise any number of play symbols. Moreover, the number of play symbols 180 comprising a game turn may be determined by the owner/administrator of system 100, also without limitation.

For example, FIG. 8 shows game turn 178 comprising a plurality of game plays 179. In this illustrated embodiment, each game play 179 comprises a question 161 and play symbol 180. Each play symbol 180 masks an answer 162. Play symbol 180 is a graphic presented to user 101 on a display screen of remote computing device 112. The graphic may be a shape, such as a star, a character, or any other graphic symbol, without limitation. After user 101 interacts with remote computing device 112 indicating user 101's decision whether to accept or reject coupon 104, remote computing device 112 removes play symbol 180, unmasking a single underlying answer 162. A correct answer 162 may be any number, letter, word, picture, or other information necessary to correctly respond to question 161. Question 161, in turn, is any sort of “question” with a missing component, the missing component supplied by the correct answer 162. In an embodiment wherein question 161 is a common phrase, such as “Roses are ______,” the correct answer 162 is “red,” for example. Unmasked answer 162 underlying any chosen play symbol 180 need not be “red,” however. Array 163 comprises play symbols masking both correct answers 162 and incorrect answers 162, in some embodiments. Whether answer 162 revealed when system 100 removes play symbol 180 is a correct answer 162 depends upon which play symbol 180 user 101 chooses from the displayed array 163 of play symbols 180. The number of play symbols 180 comprising array 163 in any specific embodiment of system 100 depends upon the game design. Moreover, the number of available correct answers to questions 161 underlying play symbols 180 present in array 163 may also be designated by the game design. The odds of a winning play signal, created by remote computing device 112 wherein a plurality of questions 161 are correctly completed with correct answers 162 may be designed into each specific embodiment of system 100. In this way, different numbers of advertisements 103 must be viewed and interacted with by user 101. It is to be understood that system 100 may, therefore, be tailored in many configurations specific to the number and kinds of advertisers 102 represented on system 100, to the number and demographic characteristics of users 101, and other factors relevant to individual applications and embodiments of system 100, without limitation.

In one embodiment, for example, game turn 178 allows user 101 to choose six play symbols 180 from array 163, representing six masked answers 162 to six questions 161. Each question 161, in this example embodiment, is a common phrase with a missing word. Each answer 162 may or may not be the correct missing word for one of the six questions 161. User 101 must identity each correct answer 162, such as the missing words in this example. As user 101 attempts to identify the six missing words by unmasking each play symbol 180, a correct answer 162 may be displayed in a particular color, such as green, while an incorrect answer may be displayed in a different color, such as red.

To unmask one play symbol 180, user 101 must view one advertisement 103 and decide whether to accept the attached coupon 104. In one example, user 101 must view a 5-second banner ad. At the end of the 5-second banner ad, user 101 receives coupon 104 and must choose whether to accept or reject coupon 104. After user 101 selects whether to accept coupon 104, play symbol 180 is removed from answer 162, unmasking answer 162, wherein user 101 views all questions 161 to determine whether unmasked answer 162 is a correct response to any question 161 comprising game turn 178. To complete game turn 178, in this example, user 101 must view and cognitively interact with at least six coupon offers. It is to be understood that user 101 may randomly select to accept or reject coupon 104 without any cognitive interaction with advertisement 103 whatsoever. Regardless, it will be presumed that the majority of users 101 will, in fact, view and consider the product offered in the advertisement prior to choosing whether to accept coupon 104.

In some embodiments, user 101 may receive additional plays in order to successfully complete game turn 178 by causing remote computing device 112 to send a winning play signal 183 to game server 115. In some embodiments, user 101 may receive a plurality of additional plays to complete game turn 178. In some embodiments, user 101 may initiate receipt of a limited number of game turns 178 onto remote computing device 112 in a set time period. In some embodiments, user 101 may initiate receipt of an unlimited number of game turns 178 onto remote computing device 112 within any time period. In some embodiments, play symbol 180 masks a jackpot “instant win,” rather than answer 162, wherein game server 116 sends user payment 197 to remote computing device 112 without further game play by unmasking of sufficient correct answers 162 to complete game turn 178. An owner/administrator of system 100 may change rules of play, odds of user 101 winning a prize, distribution of advertiser payments received 192, according to requirements and parameters particular to the owner/administrator's business.

Correct answers 162 may be randomly distributed throughout array 163. In some embodiments, there is only a single (masked) correct answer 162 for each question 161 present in array 163. In some embodiments, there is any plurality of correct answers 162 to each question 161 present in array 163. The number of correct answers 162 and the ratio of incorrect answers 162 to correct answers 162 presented in array 163 depends upon the odds of user 101 winning user payment 197 determined by the owner/administrator of system 100.

In some embodiments, multiple game turns 178 are “played” on the same array 163, such that each time user 101 selects a single play symbol 180 from array 163, that play symbol 180 is removed and not replaced by a new play symbol 180 inserted into array 163. Such embodiments of play change the odds of user 101 unmasking correct answers 162 for each question 161 and “winning” the game, wherein game server 115 sends user payment 197 to remote computing device 112. The aforementioned is one example of many possible ways an owner/administrator of system 100 may change the odds of user 101 successfully completing a game turn 178 by submitting a winning play signal 183 wherein user 101 receives a share of a prize, according to how a plurality of advertiser payments 195 are distributed.

As shown in FIG. 4, remote computing device 112 receives user payment 197 from game server 115 in response to sending winning play signal 183 to game server 115. User payment 197 may comprise an electronic cash payment or voucher, a non-cash “prize” item or service, or the like. User 101 may then redeem the cash or other item of value received on user computing device 112 via user payment 197 in any available manner known in the art, such as by electronic bank deposit, request for shipment of an item, performance of a service, or the like.

In some embodiments, remote computing device 112 collects demographic data (not shown) from user 101 and provides this demographic data to game server 115. Demographic data particular to user 101 may include birthdate and/or age, gender, geographic locator information, such as a zip code; marital status and number of children, and the like. This list of demographic data is by way of example and not intended to be limiting; any sort of demographic or other information useful to advertiser 102 may be collected by system 100, so long as user 101 consents to provide the requested information. In some embodiments, submission of demographic data by user 101 through remote computing device 112 is a requirement of system 100 to verify registration of user 101 prior to allowing further interaction of remote computing device 112 with game server 115. I some embodiments, demographic information is compiled and provided to advertiser 102, such as advertiser-specific analytics of individual ads . . . i.e. how many user viewed an ad, rates of retention for specific coupons, and the like.

First utility 159 may utilize ad selection algorithm 107 to pair specific play groups 181 to a specific user 101 based upon demographic data collected from that user 101. For example, first utility 159 utilizes ad selection algorithm 107 to target each user 101 based upon a pool of demographic information such that each user 101 receives an offer for coupon 104 specifically tailored to that user 101, increasing the chances that user 101 will accept coupon 104. Such demographic information is collected from remote computing device 112 by game server 115 at some point prior to initiation of “game play,” such as through a one-time user registration process, for example.

Described herein above is a system and process for delivering advertising. The system comprises game server, a coupon server, and a payment server which interact with a user of the system through a remote computing device. The system provides a “game,” wherein a user may “win” a chance to share in a prize, such as a cash prize. The system presents the user with a series of coupon offers submitted by advertisers, wherein the system requires the user to view and evaluate each coupon offer and to decide whether to retain the coupon prior to receiving each of a plurality of game plays. Advertisers pay to populate the system with ads, creating a payment pool from which user payments and a system profit are funded. Thus, the disclosed system and process provides a means for advertisers to ensure advertising material is considered only by interested consumers, without inefficient generation of large amounts of advertising material for presentation to disinterested consumers.

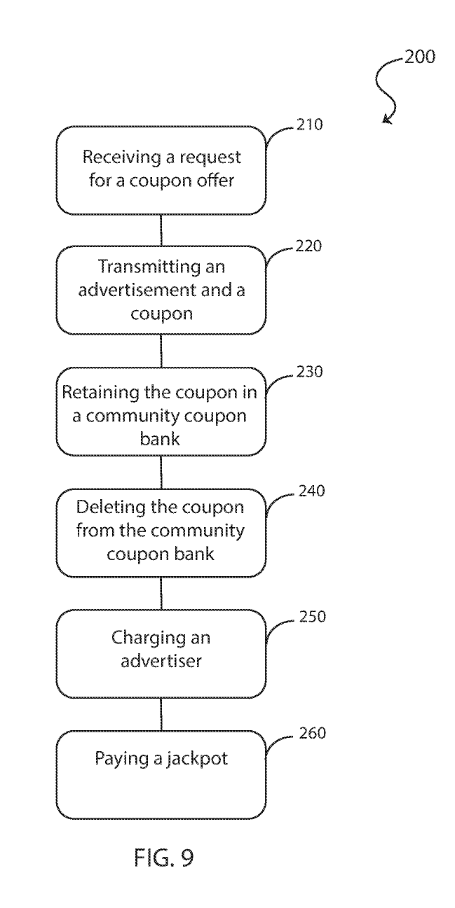

FIG. 9 shows a block diagram of a method of providing an advertisement to a consumer. As shown by FIG. 9, a method 200 comprises a receiving step 210, a transmitting step 220 a retaining step 230, a deleting step 240, a charging step 250, and a paying step 260.

Receiving step 210, comprises receiving a request for a coupon offer. An advertiser receives the request for the coupon offer from an administrator of a system for delivering advertising of a product, whether goods or services, offered by the coupon, wherein a potential consumer is playing a game on a remote computing device. The game is coupled to advertising, wherein to receive game plays, the potential consumer must view and cognitively interact with the coupon offer. The request is received by a second computing device, such as a server, a processor, or a storage device.

Transmitting step 220, comprises transmitting an advertisement and a coupon. The second computing device transmits the advertisement and the coupon to the remote computing device. Transmitting step 220 is accomplished, in some embodiments, over a computer network, such as the Internet, a cellular network, a local area network, or the like. The network may be a wired network or a wireless network. Transmitting step 220 may additionally comprise transmitting a masked game play coupled to the coupon and the advertisement in some embodiments.

Retaining step 230 comprises retaining the coupon in a community coupon bank. The community coupon bank is a computing, server, or data storage device which stores data specific to a plurality of coupons and related advertisements, from a plurality of advertisers. The community coupon bank may be resident on the second computing device. In some embodiments, the community coupon bank is resident on a third computing device.

Deleting step 240 comprises deleting the coupon from the community coupon bank. In some embodiments, the coupon is retained in the community coupon bank until a user of the remote computing device receives an offer for the coupon and chooses to accept the coupon, wherein the coupon is sent to the remote computing device for redemption by the user, and deleted from the community coupon bank.

Charging step 250 comprises charging an advertiser. The advertiser is charged in exchange for placing the advertiser's advertisement and coupon in the community coupon bank, wherein the coupon is subsequently selected for offer to a potential consumer. The sequential point in method 200 wherein charging step 250 is performed may vary. In some embodiments, for example, charging step 250 is performed prior to receiving step 210. In some embodiments, charging step 250 is performed after deleting step 340. Charging step 250 involves charging a sum of money which may depend on various factors, including factors particular to an individual advertiser, the product being advertised, whether the coupon offered to the user is accepted or rejected by the user, demographic characteristics of the user, and so on. In some embodiments, all advertisers are charged a flat amount regardless of whether the advertiser's coupon offer is accepted or rejected. Charging the advertiser is performed by any commercially available billing and payment means used in personal or commercial transactions.

Paying step 260 comprises paying a jackpot. The “jackpot” is a prize, such as a sum of money, an item, or a promise to perform a service. A user of the remote computing device receives the payment. In some embodiments, the jackpot is divided among a plurality of users of remote computing devices who have submitted a winning game play, and, consequently, received a chance to share in the jackpot.

It is understood, therefore, that method 200 comprises steps wherein for a fee charged, an advertiser may present an advertisement comprising a coupon offer to a potential consumer. The consumer is compelled to view and make an “accept or deny” decision regarding the coupon offer in exchange for a chance to play a game wherein a winner or a plurality of winners will share in a prize, such as a cash payment. The advertiser is motivated to participate to have its products considered only by interested consumers, versus wasting advertising resources on persons who do not wish to receive advertising, and who would likely not consider purchasing the advertiser's product. The potential consumer/user is motivated to participate by the amusement of playing a simple game for a chance to win a lottery-type prize, and to collect discount coupons only on products of interest to the user. Method 200 may include any number of additional steps, in some embodiments.

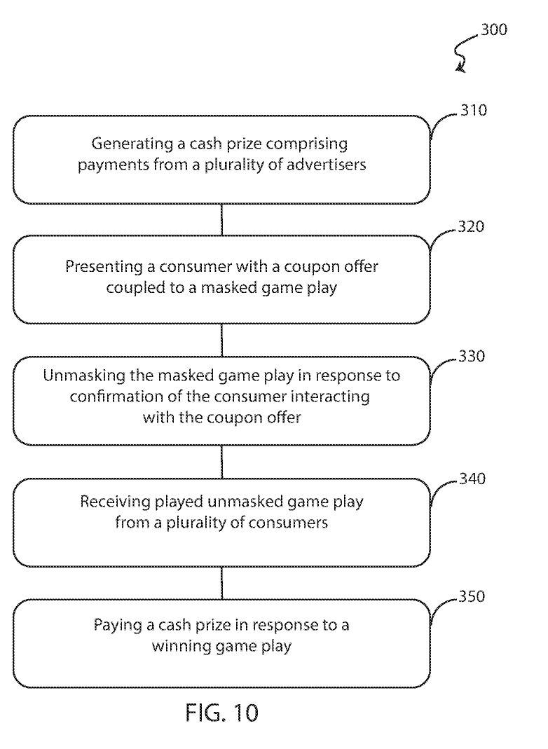

FIG. 10 shows a block diagram of a method of compelling a consumer to interact with an advertisement. As shown by FIG. 10, method 300 comprises a generating step 310, a presenting step 320, an unmasking step 330, a receiving step 340, and a paying step 350.

Generating step 310 comprises generating a cash prize comprising payments from a plurality of advertisers. Payments from advertisers are pooled to create a cash prize, the cash prize being used to incentivize potential consumers to view and make a cognitive decision regarding the advertisement.

Presenting step 320 comprises presenting a consumer with a coupon offer coupled to a masked game play. In order for the consumer to “unmask” and play the game play for a chance to win a share of the cash prize, the consumer must interact with the coupon offer.

Unmasking step 330 comprises unmasking the masked game play in response to confirmation of the consumer interacting with the coupon offer. Unmasking the masked game play “rewards” the consumer for its interaction by revealing the game play, wherein the consumer may now utilize the game play in an attempt to win a chance to share the prize.

Receiving step 340 comprises receiving a played unmasked game play from a plurality of consumers. The unmasked game play is received by a second computing device, in some embodiments, comprising a server, a computing device, or a memory device, in some embodiments. The received game plays are tallied, wherein the second computing device determines winning game plays and calculates distribution of cash payments to a plurality of consumer users who have submitted winning game plays.

Paying step 350 comprises paying a cash prize in response to a winning game play. Paying step 350 completes method 300, wherein the consumer user who was compelled to view and cognitively interact with the advertisement may receive a reward for participating—viewing and considering the advertisement—with a prize.

Method 300 may include other steps. For example, in some embodiments, a verification step comprises sending demographic data to the advertiser comprising information about users who accept the coupon offer and users who reject the coupon offer. Based upon this information, the advertiser may know the types of ads most viewed by consumers, the effectiveness of individual ads, and the like.

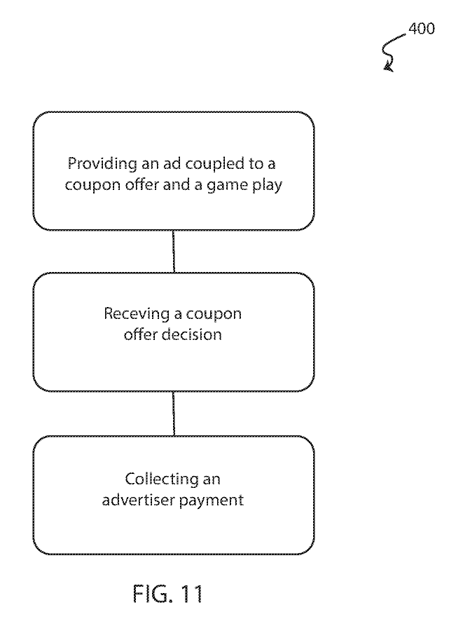

FIG. 11 shows a block diagram of a method for collecting advertiser revenue. As shown by FIG. 11, method 400 comprises a providing step 410, a receiving step 420, and a collecting step 430.

Providing step 410 comprises providing an ad coupled to a coupon offer and a game play. The ad is provided by an advertiser, and includes a coupon. In some embodiments, the ad is provided to a system comprising a computing device, a server, or a data storage device for presentation to a potential consumer of the advertised product who is a user of the system.

Receiving step 420 comprises receiving a coupon offer decision. In some embodiments, the potential consumer/user of the system is compelled to view the advertisement and log a decision whether to keep or reject the coupon. In some embodiments, the computing device receives the coupon offer decision from a remote computing device operated by the potential consumer/user of the system.

Collecting step 430 comprises collecting an advertiser payment. The cash prize is generated, at least in part, from payments by the advertiser received into the system. Additionally, the owner/operator of the system retains a share of a payment pool comprising payments from a plurality of advertisers. In this manner, the system generates revenue for the owner/operator of the system in proportion to the number of advertisers and number of ads provided to the system. In some embodiments, method 400 may include other additional steps.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A system for delivering advertising comprising:
a game server;
a coupon server communicatively coupled to the game server, comprising a community coupon bank;
a remote computing device communicatively coupled to the game server, wherein the game server sends an advertisement and a coupon to the remote computing device in response to receiving a game turn request from the remote computing device; and
wherein the game server sends a play symbol to the remote computing device in response to receiving one of either a reject coupon signal or an accept coupon signal from the remote computing device.

2. The system of claim 1, wherein the remote computing device is a handheld computing device.

3. The handheld computing device of claim 2, wherein an advertising system app resides on the handheld computing device and is communicatively coupled to the game server by the handheld computing device.

4. The system of claim 1, further comprising a payment server communicatively coupled to the game server, wherein
the payment server:
responds to receipt of a winning play from the game server by calculating a total payment amount;
send the total payment amount to the game server; and
the game server
calculates a plurality of user payments in response to receiving the total payment amount from the payment server; and
sends a user payment to the remote computing device.

5. The system of claim 4, further comprising a payment memory, wherein an advertiser payments received from a plurality of advertiser payments signals are stored in the payment memory.

6. The system of claim 4, further comprising a payment utility residing on the payment server, wherein the payment utility calculates
a consumer payment pool based upon the advertiser payments received and a total number of advertisers; and
a game payout pool based upon the consumer payment pool and a total number of winning plays.

7. The system of claim 6, wherein the payment utility calculates a system profit and removes the system profit from the advertiser payments received of the payment memory.

8. The system of claim 1, wherein the coupon server comprises a coupon processor;
wherein the coupon processor:
selects the coupon from the community coupon bank;
sends a coupon delivery signal to the game server; and
wherein the game server:
couples the coupon and the advertisement to the play symbol;
transmits a play group comprising the coupon and the advertisement and the play symbol to the remote computing device; and
displays the play symbol on the remote computing device, wherein selecting the play symbol from a display comprising a plurality of play symbols causes the remote computing device to simultaneously display the advertisement and the coupon on the remote computing device.

9. The system of claim 8, wherein the coupon processor transfers the coupon from the community coupon bank to a user coupon bank in response to receiving the accept coupon signal from the game server.

10. The system of claim 8, wherein the coupon processor places the coupon in the community coupon bank in response to receiving the reject coupon signal from the game server.

11. A system for delivering advertising comprising:
a game server;
a payment server communicatively coupled to the game server, comprising a consumer payment pool;
a remote computing device communicatively coupled to the game server, and
a first utility resident on the game server, wherein the first utility
sends a game turn signal comprising a plurality of game plays to the remote computing device in response to receiving a game turn request signal from the remote computing device; and
sends a user payment to the remote computing device in response to receiving a winning play signal from the remote computing device.

12. The system of claim 11, further comprising an advertiser, wherein an advertiser payment signal received by the payment server from the advertiser causes a payment utility resident on the payment server to credit the consumer payment pool with the advertiser payment signal.

13. The system of claim 12, wherein the payment utility
calculates a game payout pool in response to receipt of a total winning play signal from the game server; and
transmits a total payment to the game server.

14. A method of providing an advertisement and a coupon to a consumer comprising the steps:
receiving a request for a coupon offer from a remote computing device;
transmitting an advertisement and a coupon from a coupon server to the remote computing device;
wherein the coupon server retains the coupon in a community coupon bank in response to receiving a coupon acceptance signal from the remote computing device;
wherein the coupon server deletes the coupon from the community coupon bank in response to receiving a coupon accept signal from the remote computing device; and,
charging the advertiser
a first amount if a coupon acceptance signal is received from the remote computing device and
a second amount if a coupon reject signal is received from the remote computing device.

15. The method of claim 14, wherein the request for a coupon offer is coupled to a game play generated by a game server.

16. The method of claim 14, further comprising steps:
collecting user demographic data from the remote computing device;
transmitting the user demographic data to the game server from the remote computing device;
inputting the user demographic data into an ad selection algorithm residing on a first utility installed on the game server;
selecting an advertisement, wherein the first utility runs the ad selection algorithm to select the advertisement; and
transmitting the advertisement to the remoted computing device for display to the consumer using of the remote computing device.

17. The method of claim 14, further comprising paying a jackpot to the consumer using the remote computing device;
wherein a payment server communicatively coupled to the game server transmits a total payment to the game server; and
wherein the game server calculates a user payment and transmits the user payment to the remote computing device.

18. A method for using a lottery game to compel a consumer to interact with an advertisement comprising the steps:
generating a lottery cash prize comprising payments from a plurality of advertisers;
presenting a consumer with a coupon offer coupled to a masked game play;
unmasking the masked game play in response to confirmation of a consumer interaction with the coupon offer;
receiving played unmasked game plays from a plurality of consumers; and
paying a cash prize in response to a winning game play.

19. A method of collecting advertiser revenue comprising the steps:
providing an ad coupled to a coupon offer and a game play;
receiving a coupon offer decision; and
collecting an advertiser payment.
